(19) United States
(12) Patent Application Publication
(10) Pub. No.: US 2025/0251074 A1
(43) Pub. Date: Aug. 7, 2025

(54) SEALING CLAMP ASSEMBLY AND METHOD FOR CLEARING AND LEAK TESTING FUEL LINES OF GAS TURBINE FUEL SUPPLY SYSTEM

(71) Applicant: GE Infrastructure Technology LLC, Greenville, SC (US)

(72) Inventors: Jesus Barrera Perez, Queretaro (MX); Salvador Zavala Perez, Queretaro (MX); Jose Luis Garcia Arellano, Queretaro (MX)

(21) Appl. No.: 18/429,922

(22) Filed: Feb. 1, 2024

(51) Int. Cl. F16L 55/10; G01M 3/02

(52) U.S. Cl. CPC F16L 55/1018; G01M 3/022

(57) ABSTRACT

A clamp assembly for selectively blocking flow while clearing and leak testing a fuel line of a gas turbine fuel supply system is provided. The clamp assembly includes a clamp body configured to surround a flanged joint of the fuel line. A seal is rotatably held between the clamp body portions and includes a hollow ear in fluid communication with a center hole of the seal. The seal includes a tab or pin with which the seal can be rotated between a sealed position and an unsealed position. In the unsealed position, the hollow ear is aligned with the vent, and in the sealed position, the hollow ear is blocked by internal surfaces of the clamp body. Embodiments include a locking assembly allowing the seal to be locked in one and/or both of the open and closed positions.

### FIELD

The present disclosure relates generally to clamps and seals for a gaseous fuel circuit. Particularly, the present disclosure relates to clamps and seals for testing a gaseous fuel circuit of a gas turbine fuel supply system.

### BACKGROUND

Turbomachines are utilized in a variety of industries and applications for energy transfer purposes. For example, a gas turbine engine generally includes a compressor section, a combustion section, a turbine section, and an exhaust section in serial flow order. The compressor section progressively increases the pressure of a working fluid and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The spent combustion gases then exit the gas turbine as exhaust gases via the exhaust section.

A gas turbine fuel system delivers gaseous fuel to the combustion section to be combusted for power generation. The fuel systems generally include gas conveying manifolds and piping, gas control valves, gas stop ratio valves, and electrical components housed in a fuel module enclosure. As such, the fuel module enclosure typically includes a ventilation system to evacuate any gas leaks within the enclosure. Additionally, a separate leak detection system is used to detect any potential fuel leakage from components within the enclosure.

The gaseous fuel is conveyed through fuel conveying components within the enclosure, such as piping, manifolds, connection flanges, and/or valves for delivery to the combustion section of the gas turbine engine. Fuel lines are typically put through an “air blow” procedure after installation or repair to clear the lines of debris, such as dirt, dust, soot, metal or plastic shavings, and the like. In an air blow procedure, a number of fuel lines are sealed while air is blown through others that are left open. The lines that have been blown are then capped, and another group of lines is blown, and so on, until all fuel lines have been blown. In addition, the fuel delivery system, in part or as a whole, can be tested for leaks after installation or repair, typically after the air blow procedure. In both leak tests and air blows, the sealed lines are capped using blind seals that must be bolted onto flanges of the lines, which can be time consuming, particularly during an air blow procedure, and particularly for systems having twelve or more fuel lines. In some cases, the seals used for air blows are not suitable for use in leak tests, which results in swapping seals when a leak test is to be performed after an air blow, adding yet more time and labor to the job.

### BRIEF DESCRIPTION

Aspects and advantages of the clamp assembly and fuel supply systems in accordance with the present disclosure will be set forth in part in the following description, or may be obvious from the description, or may be learned through practice of the technology. All aspects, examples and features mentioned below can be combined in any technically possible way.

An aspect of the disclosure provides a clamp assembly for selectively blocking flow from a flanged joint of a fuel line of a gas turbine fuel supply system, the clamp assembly comprising: a clamp body configured to surround the flanged joint of the fuel line, the clamp body including an outer wall with a first vent formed therethrough; and a seal movably mounted in and support by the clamp body, the seal including: a central opening defined in a top of the seal and in fluid communication with an interior of the seal; and a first exit passage defined in the seal and in fluid communication with the interior of the seal and with an exterior of the seal, wherein the seal is movable between an unsealed position in which the central opening is in fluid communication with an exterior of the clamp assembly through the first exit passage and the first vent, and a sealed position in which fluid communication from the central opening to the exterior of the clamp body through the first exit passage is blocked by the clamp body.

Another aspect of the disclosure includes any of the preceding aspects, and wherein the first exit passage is aligned with the first vent in response to the seal being in the unsealed position, and wherein the first exit passage is completely covered by the outer wall of the clamp body in response to the seal being in the sealed position.

Another aspect of the disclosure includes any of the preceding aspects, and wherein the seal includes a first ear projecting radially from the seal body and that defines at least part of the first exit passage.

Another aspect of the disclosure includes any of the preceding aspects, and wherein the seal includes a second exit passage defined in the seal body in fluid communication with the interior of the seal and with the exterior of the seal; wherein the clamp body further includes a second vent through the outer wall of the clamp body; and wherein the second exit passage is aligned with the second vent in response to the seal being in the unsealed position, and the second exit passage is completely covered by the clamp body outer wall of the clamp body in response to the seal being in the sealed position.

Another aspect of the disclosure includes any of the preceding aspects, and wherein the seal further includes a second ear circumferentially spaced from the first ear, and each of the first ear and the second ear project radially from the seal body and define at least part of the first exit passage and the second exit passage, respectively.

Another aspect of the disclosure includes any of the preceding aspects, and wherein the clamp body further includes a first portion connected to a second portion.

Another aspect of the disclosure includes any of the preceding aspects, and wherein the first portion and the second portion are pivotably connected and are movable between: an open clamp position in which at least one of the first portion or the second portion is disengaged from the seal; and a closed clamp position in which the first portion and the second portion engage the seal and are configured to retain the clamp assembly on the flanged joint.

Another aspect of the disclosure includes any of the preceding aspects, and wherein each of the first portion and the second portion includes a respective outer wall section, opposed end walls extending radially inward from the respective outer wall section as a top wall and a bottom wall, and a tongue extending from an end of the respective first or second portion.

Another aspect of the disclosure includes any of the preceding aspects, and wherein the opposed end walls are sized and configured to hold the clamp assembly on the flanged joint.

Another aspect of the disclosure includes any of the preceding aspects, and wherein the tongue of the first portion is positioned between the end walls of the second portion adjacent the first portion; and wherein the first portion and the second portion are pivotably connected by a pivot pin extending through corresponding holes formed through the tongue of the first portion and through the end walls of the second portion adjacent the tongue of the first portion.

Another aspect of the disclosure includes any of the preceding aspects, and wherein, when the clamp assembly is in a closed clamp position: the tongue of the second portion is positioned between the end walls of the first portion adjacent the second portion at a location circumferentially spaced from the pivot pin; and a removable locking pin extends through corresponding holes formed through the tongue and through the end walls of the first portion adjacent the tongue of the second portion.

Another aspect of the disclosure includes any of the preceding aspects, and further including an actuator accessible from the exterior of the clamp assembly and operable to move the seal between an unsealed position in which the interior of the seal is in fluid communication with an exterior of the clamp assembly through the first exit passage and the first vent, and a sealed position in which fluid communication from the interior of the seal to the exterior of the clamp body through the first exit passage is blocked.

Another aspect of the disclosure includes any of the preceding aspects, and wherein the actuator extends from the seal to the exterior of the clamp assembly.

Another aspect of the disclosure includes any of the preceding aspects, and wherein the actuator further includes a lock plate that interacts with a feature on the clamp body to selectively retain the seal in each of the unsealed position and the sealed position.

Another aspect of the disclosure includes any of the preceding aspects, and wherein the lock plate includes a detent that interacts with the feature on the clamp body; wherein, when the seal is in the sealed position, the feature on the clamp body that interacts with the detent is a pivot pin coupling the first portion and the second portion; and wherein, when the seal is in the unsealed position, the feature on the clamp body that interacts with the detent is a lock projection extending from the clamp body and circumferentially spaced from the pivot pin.

Another aspect of the disclosure includes any of the preceding aspects, and wherein the outer wall is substantially annular, and the seal is substantially toroidal.

Another aspect of the disclosure provides a method comprising: removing flex lines of fuel lines of a fuel supply system of a gas turbine engine from respective flanged joints thereof, thereby exposing respective flanges thereof; installing a respective clamp assembly on each flange, each clamp assembly having a first state in which flow through the flange is allowed and a second state in which flow through the flange is blocked; selecting a group of fuel lines to be cleared; placing the respective clamp assemblies of all fuel lines other than the group of fuel lines to be cleared in the second state; placing the respective clamp assemblies of the group of fuel lines in the first state; clearing the group of fuel lines; repeating selecting a group of fuel lines, placing the respective clamp assemblies in an appropriate first state or second state, and clearing the fuel lines in groups until all fuel lines have been cleared; removing the clamp assemblies; and reattaching the flex lines to the flanges.

Another aspect of the disclosure includes any of the preceding aspects, and wherein placing the respective clamp assemblies in at least one of the first state or the second state includes locking the respective clamp assemblies.

Another aspect of the disclosure includes any of the preceding aspects, and further comprising, after all fuel lines have been cleared and before removing the clamp assemblies, performing a leak test by: placing all clamp assemblies in the second state; pressurizing the fuel supply system; examining the fuel supply system for leaks; addressing each detected leak, if any; repeating examining and addressing until no leak is detected; depressurizing the system; removing the clamp assemblies; and reattaching the flex hoses to the flanges.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 schematically illustrates a turbomachine (e.g., a gas turbine engine), in accordance with embodiments of the present disclosure;

FIG. 2 schematically illustrates a fuel supply system for a gas turbine engine, in accordance with embodiments of the present disclosure;

FIG. 3 illustrates a combustion can with a flanged connection to a fuel circuit such as that shown in FIGS. 2 and 3, in accordance with embodiments of the present disclosure;

FIG. 4 illustrates a perspective view of a prior art flanged joint used in the fuel supply system of FIGS. 2 and 3;

FIG. 5 illustrates additional aspects of the fuel circuit shown in FIG. 2, and an enlarged perspective view of a prior art seal assembly usable therewith during an air blow/clearing procedure;

FIG. 6 illustrates an enlarged perspective view of two examples of a flanged joint as seen in FIG. 4 but with a sealing clamp assembly in accordance with embodiments of the present disclosure installed in place of the prior art seal assembly of FIG. 5;

FIG. 7 illustrates a perspective view of a seal of a sealing clamp assembly, in accordance with embodiments of the present disclosure;

FIG. 8 illustrates a perspective view of a sealing clamp assembly with the clamp body open, in accordance with embodiments of the present disclosure;

FIG. 9 illustrates a perspective view of a sealing clamp assembly with the clamp body closed and the seal in an unsealed position/state, in accordance with embodiments of the present disclosure;

FIG. 10 illustrates a perspective view of a sealing clamp assembly with the clamp body closed and the seal in a sealed position/state, in accordance with embodiments of the present disclosure;

FIGS. 11-14 illustrate schematic top views of a sealing clamp assembly with one vent, in accordance with embodiments of the present disclosure;

FIGS. 15-18 illustrate schematic top views of a sealing clamp assembly with two vents, in accordance with embodiments of the present disclosure;

FIG. 19 illustrates a method of using embodiments of the sealing clamp assembly of FIGS. 7-12, in accordance with embodiments of the present disclosure;

FIG. 20 illustrates the fuel supply system of FIG. 5, but with sealing assemblies according to embodiments of the present disclosure installed in place of the prior art seal assembly shown in FIG. 5.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

Reference now will be made in detail to embodiments of a sealing clamp assembly and method for clearing and leak testing fuel lines of a gas turbine fuel supply system, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

As an initial matter, in order to clearly describe the current disclosure, it will become necessary to select certain terminology when referring to and describing relevant machine components within the illustrative application of a sealing clamp assembly and method for clearing and leak testing fuel lines of a gas turbine fuel supply system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or fuel through one of the turbomachine's fuel supply lines. The term “downstream” corresponds to the direction of flow of the fluid, and the term “upstream” refers to the direction opposite to the flow. The terms “forward” and “aft,” without any further specificity, refer to directions, with “forward” or “fore” referring to the front or compressor end of the turbomachine, and “aftward” or “aft” referring to the rearward or turbine end of the turbomachine.

It is often required to describe parts that are at different radial positions with regard to a center axis. The term “axial” refers to movement or position parallel to an axis, e.g., an axis of a turbomachine. The term “radial” refers to movement or position perpendicular to an axis, e.g., an axis of a turbomachine. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a casing extending about an axis of a turbomachine. As indicated above, it will be appreciated that such terms may be applied in relation to the axis of the turbomachine.

In addition, several descriptive terms may be used regularly herein, as described below. The terms “first,” “second,” and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

The term “fluid” may be a gas or a liquid. The term “fluid communication” means that a fluid is capable of making the connection between the areas specified.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” or “substantially vertical” includes directions within ten degrees of vertical in any direction, e.g., clockwise or counter-clockwise.

As used herein, the term “line” may refer to a fluid carrying conduit, such as a pipe, manifold, hose, tube, or other suitable fluid carrying conduits.

Here and throughout the specification and claims, in embodiments in which range limitations may be combined and interchanged, such ranges are identified and include all the sub-ranges contained therein unless context or language indicates otherwise. For example, all ranges disclosed herein are inclusive of the endpoints, and the endpoints of overlapping ranges are independently combinable with each other.

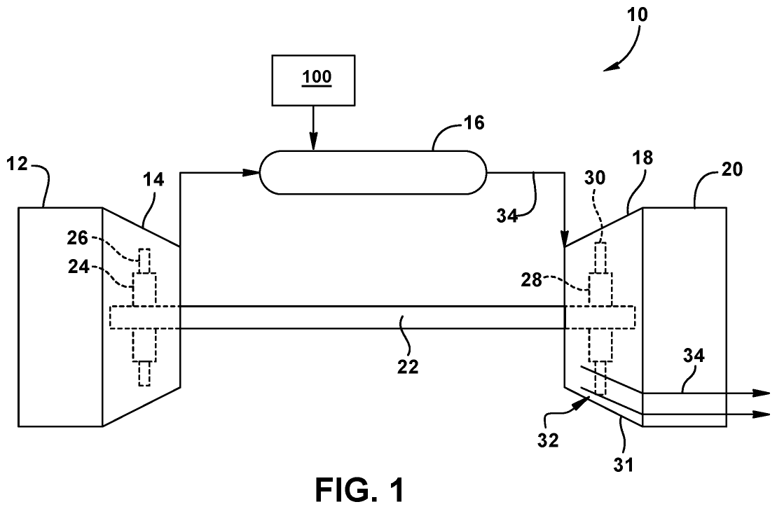

Referring now to the drawings, FIG. 1 illustrates a schematic diagram of one embodiment of a turbomachine, which in the illustrated embodiment is a gas turbine engine 10. Although an industrial or land-based gas turbine is shown and described herein, the present disclosure is not limited to an industrial and/or land-based gas turbine unless otherwise specified in the claims. For example, the assemblies and systems as described herein may be used in any type of turbomachine including but not limited to a steam turbine, an aircraft gas turbine, or a marine gas turbine.

As shown, gas turbine engine 10 generally includes an inlet section 12, a compressor section 14 disposed downstream of inlet section 12, a plurality of combustors (not shown) within a combustion section 16 disposed downstream of compressor section 14, a turbine section 18 disposed downstream of combustion section 16, and an exhaust section 20 disposed downstream of turbine section 18. Additionally, gas turbine engine 10 may include one or more shafts 22 coupled between compressor section 14 and turbine section 18.

Compressor section 14 may generally include a plurality of rotor disks 24 (one of which is shown) and a plurality of rotor blades 26 extending radially outwardly from and connected to a respective rotor disk 24. Each rotor disk 24 in turn may be coupled to or form an upstream portion of shaft 22 that extends through compressor section 14.

Turbine section 18 may generally include a plurality of rotor disks 28 (one of which is shown) and a plurality of rotor blades 30 extending radially outwardly from and being interconnected to a respective rotor disk 28. Each rotor disk 28 in turn may be coupled to or form a downstream portion of shaft 22 that extends through turbine section 18. Turbine section 18 further includes an outer casing 31 that circumferentially surrounds the downstream portion of shaft 22 and rotor blades 30, thereby at least partially defining a hot gas path 32 through turbine section 18.

In exemplary embodiments, gas turbine engine 10 may further include a fuel supply system 100 fluidly coupled to combustion section 16. Fuel supply system 100 may supply gaseous fuel (such as natural gas, hydrogen, or other gaseous fuel) to combustion section 16.

During operation, a working fluid such as air flows through inlet section 12 and into compressor section 14 where the air is progressively compressed, thus providing pressurized air to the combustors of combustion section 16. The pressurized air is mixed with fuel (e.g., gaseous fuel from fuel supply system 100) and burned within each combustor to produce combustion gases 34. Combustion gases 34 flow through hot gas path 32 from combustion section 16 into turbine section 18, wherein energy (kinetic and/or thermal) is transferred from combustion gases 34 to rotor blades 30, causing shaft 22 to rotate. The mechanical rotational energy may then be used to, for example, power compressor section 14 and/or to generate electricity. Combustion gases 34 exiting turbine section 18 may then be exhausted as an exhaust gas from gas turbine engine 10 via exhaust section 20.

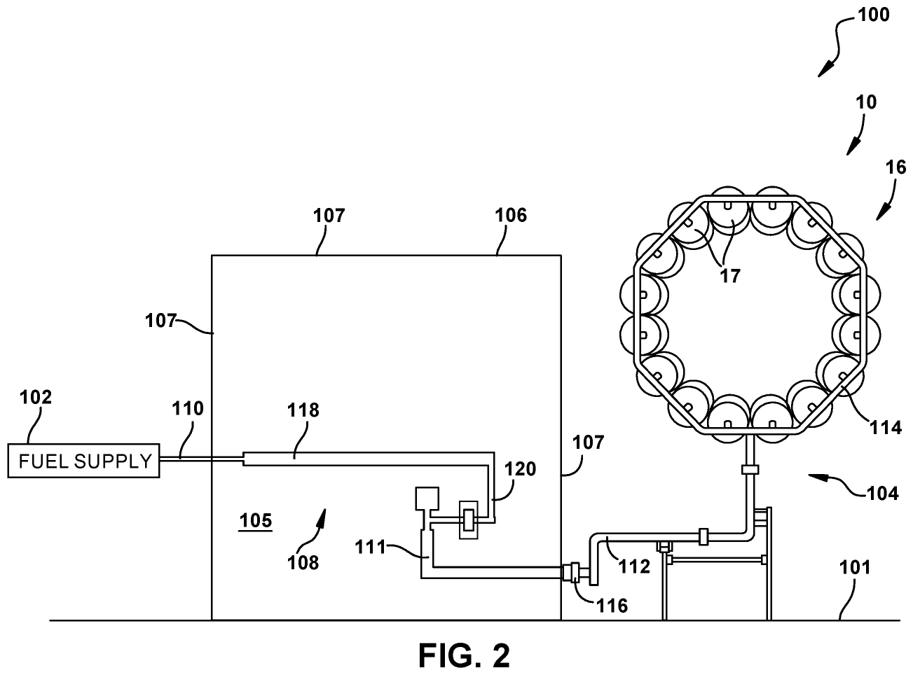

Referring now to FIG. 2, a schematic of a fuel supply system 100 for gas turbine engine 10 is illustrated, in accordance with embodiments of the present disclosure. As shown, fuel supply system 100 may be fluidly coupled to combustion section 16 of gas turbine engine 10. For example, combustion section 16 may include a plurality of combustion cans 17 in a generally circular array about the shaft 22, and fuel supply system 100 may be fluidly coupled to each combustion can 17 of the plurality of combustion cans 17, as discussed below.

Fuel supply system 100 may include a fuel supply 102, an accessory system 104, an enclosure 106, and a fuel circuit 108 disposed at least partially within enclosure 106. Fuel supply 102 may be a tank, container, reservoir, pipeline, or other source of fuel (such as natural gas, hydrogen, diesel, gasoline, or other fuel). Fuel supply 102 may fluidly couple to fuel circuit 108 via an inlet line 110, and fuel circuit 108 may fluidly couple to accessory system 104 via an outlet line 111. Additional components may be interposed between inlet line 110 and outlet line 111, such as a manifold 118 and a branch line 120, which may be disposed within enclosure 106.

Enclosure 106 may include walls 107 that collectively surround a majority of fuel circuit 108. Enclosure 106 may be disposed on a floor 101 (such as the ground or a concrete pad). In exemplary embodiments, enclosure 106 may define an interior 105 (e.g., the interior may be defined collectively by walls 107 and/or floor 101). The various components of fuel circuit 108 may be disposed within interior 105 of enclosure 106.

The accessory system 104 is fluidly coupled to each combustion can 17 of the plurality of combustion cans 17. For example, the accessory system 104 may include a connection line 112 and a distribution ring 114. The connection line 112 may extend between a connection flange 116 and the distribution ring 114. The connection line 112 may fluidly couple to outlet line 111 of fuel circuit 108 outside of enclosure 106. That is, outlet line 111 may extend through a wall 107 of enclosure and fluidly couple to the connection line 112 of the accessory system 104. The distribution ring 114 may extend about an axial centerline of the gas turbine engine 10 and fluidly couple to each of the combustion cans 17.

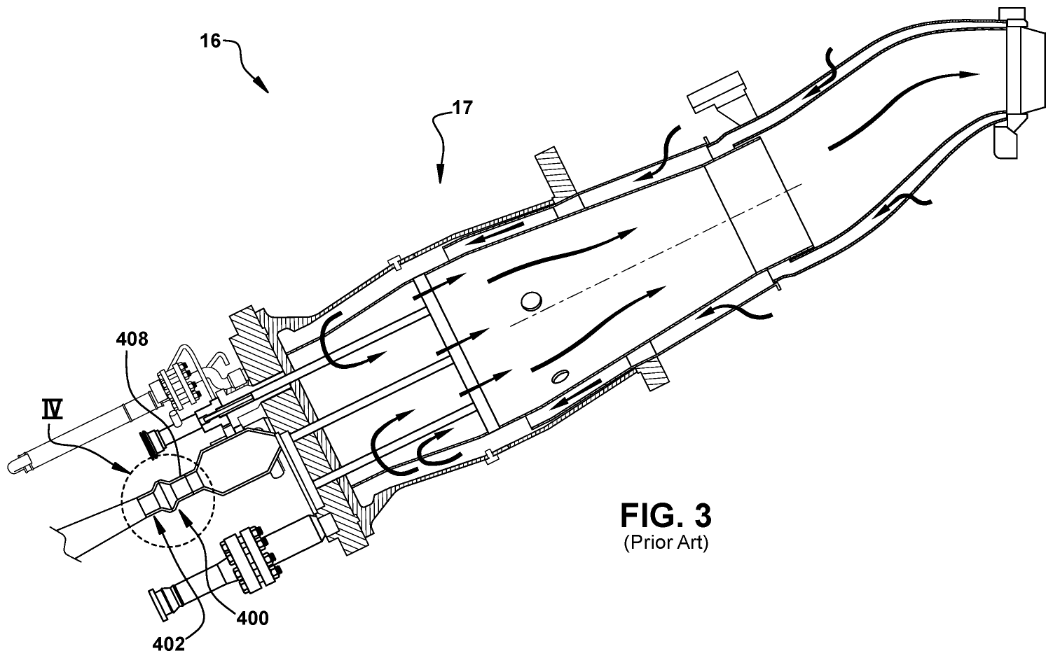

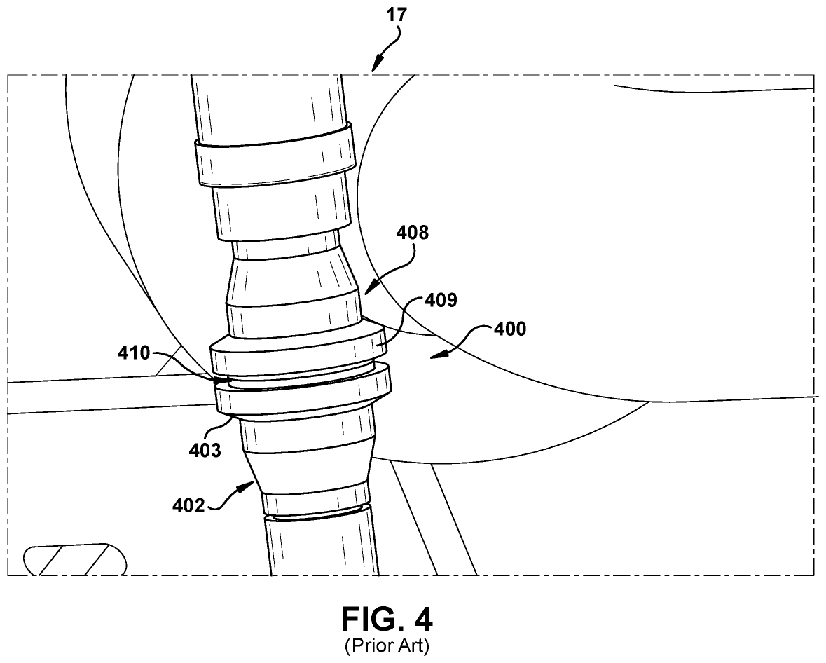

FIG. 3 illustrates a combustion can 17 with a flanged joint 400 connecting a combustion side line 408 and a fuel line 402 of a fuel circuit, such as the distribution ring 114 shown in FIG. 2. An enlarged perspective view of flanged joint 400 within dashed circle IV of FIG. 3 is shown in FIG. 4. As particularly seen in FIG. 4, each fuel line 402 can connect to a combustion side line 408 via a respective flanged joint 400. Flanged joint 400 can include a first flange 403 at an end of fuel line 402 and a second flange 409 at an end of combustion side line 408. For operation, a seal assembly 410 can be interposed and held between first and second flanges 403, 409 to prevent fuel leakage to the surroundings. Fuel lines 402 can include or take the form of flex lines connected to first flanges 403.

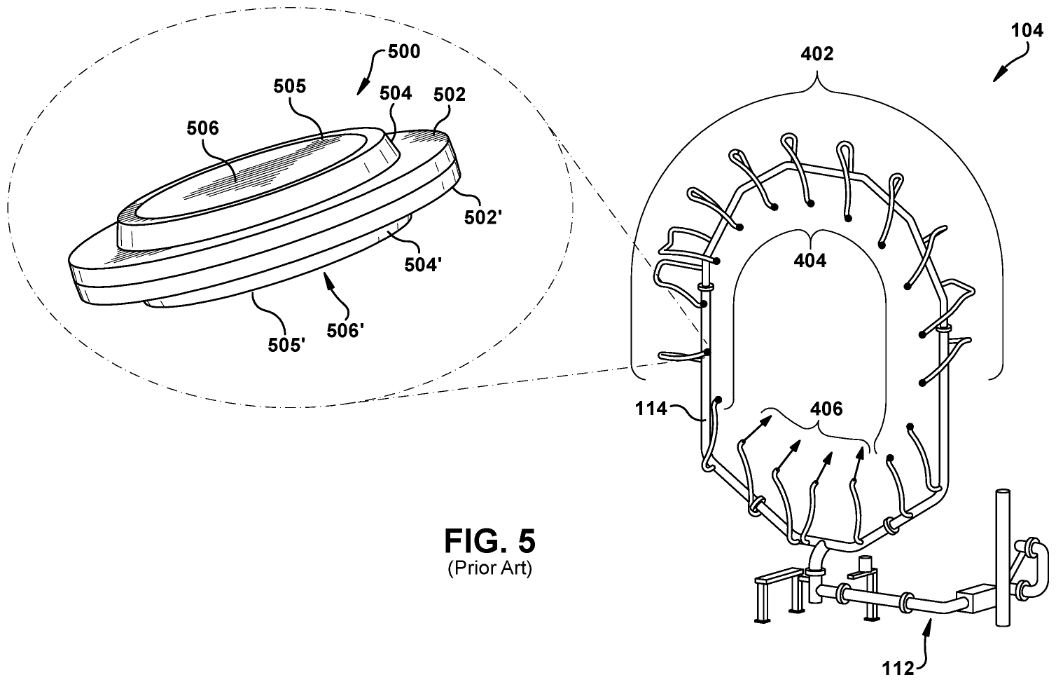

FIG. 5 illustrates additional aspects of the fuel circuit shown in FIG. 2 during an air blow procedure. As seen in FIG. 5, each of a plurality of fuel lines 402 can connect distribution ring 114 to a respective combustion can 17 (FIG. 3). At a stage of an air blow or clearing procedure illustrated in FIG. 5, most of fuel lines 402 are sealed fuel lines 404 and a group of fuel lines to be cleared 406 are unsealed. Such a procedure is typically performed after installation of fuel lines 402 to clear dirt, soot, metal shavings, and/or other debris and will be described in more detail below.

Sealed fuel lines 404 are typically capped or sealed with a blind seal 500 shown in the enlarged inset in FIG. 5, and once open lines 406 are cleared, they are capped and a group of sealed fuel lines 404 are opened. This process is repeated until all of fuel lines 402 have been cleared. As seen in the inset of FIG. 5, a blind seal 500 typically includes a first seal 502 with a first lip 504 shaped to engage first flange 403 or second flange 409. First lip 504 can include a first hole 505 therethrough that is blocked by a first wall 506. Thus, when installed, first wall 506 prevents flow through blind seal 500. First wall 506 can be a bottom wall of first seal 502, a top wall flush with a top of first lip 504, or other arrangement as may be suitable or desired. Blind seal 500 can include a second seal 502′ with a respective second lip 504′ and a respective second wall 506′, though second wall 506′ can be omitted.

In a typical air blow or clearing procedure for gas turbine fuel lines or fuel supply systems, referring to FIGS. 4 and 5, fuel lines 402 are disconnected from flanged joints 400 and can be sealed using respective blind seals 500, as illustrated by sealed lines 404. A group of lines to be tested 406 is opened by removing respective blind seals 500, blowing air through the group of lines to be tested 406, replacing blind seals 500. The steps are repeated with a next group of lines to be tested. The opening, blowing, and sealing steps are repeated on groups of lines 406 until all fuel lines 402 are cleared, at which point all fuel lines 402 can be reconnected to combustion side lines 408 of cans 17 via flanged joints 400.

When switching groups, removal and installation of blind seals 500 takes considerable effort and time. After all fuel lines 402 are blown and before reattaching fuel lines 402 to combustion side lines 408, a leak test of each fuel line 402 can be performed. However, typical blind seals 500 cannot be used for leak tests, so blind seals 500 must be removed, and other seals specific to this purpose must be employed for the leak tests, which adds more time and labor to the task. Additionally, the operator must maintain an inventory of two types of seals for the air blowing process and the subsequent leak testing, thereby increasing cost and complexity.

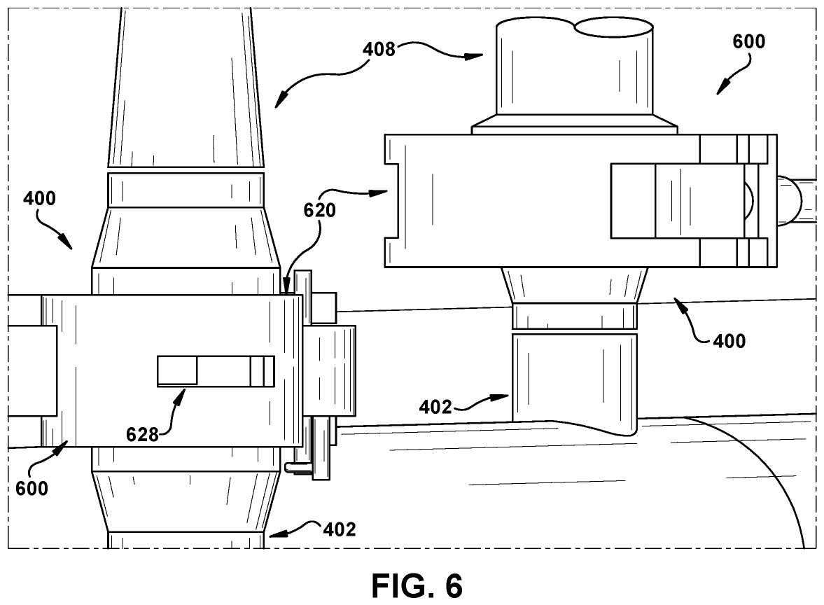

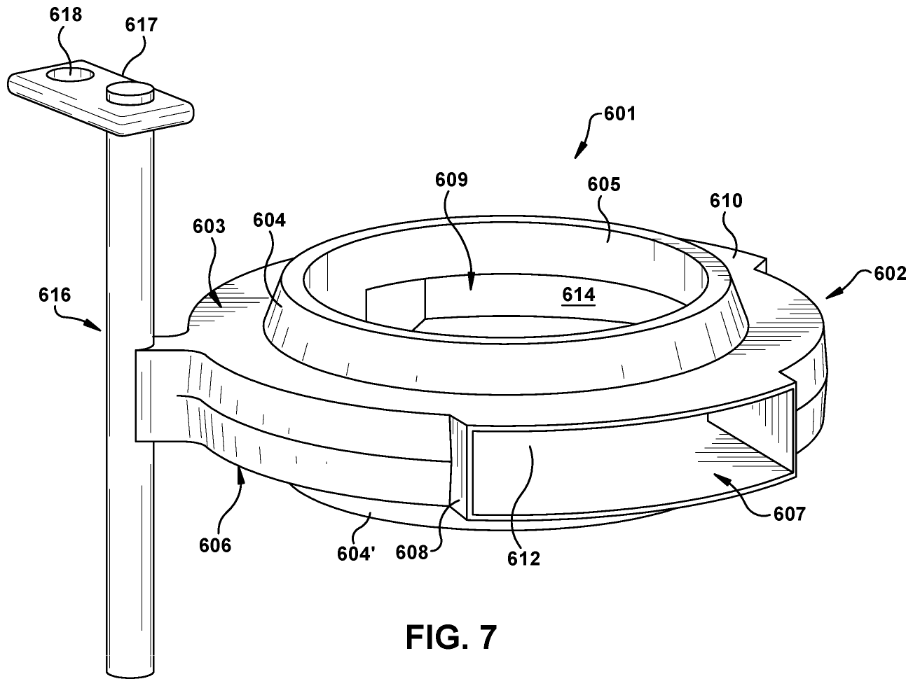

Embodiments of the present sealing clamp assembly can reduce the time and effort required for air blow/clearing procedures by remaining in place during the entire procedure. In addition, embodiments can be constructed with sufficient strength to further be used for leak tests, which allows embodiments to remain in place after an air blow/clearing procedure and during a leak test. FIG. 6 illustrates a perspective view of two examples of a sealing clamp assembly 600 usable with the fuel supply system of FIGS. 2 through 4 and in place of the prior art blind seal of FIG. 5, in accordance with embodiments of the present disclosure. Broadly, exemplary embodiments can include a clamp assembly 600 for selectively blocking flow through a flange 403, 409 (FIG. 4) of a flanged joint 400 of a gas turbine fuel supply system 100 (FIGS. 1-3). Clamp assembly 600 can be installed between a fuel line 402 and a combustion side line 408 to selectively block flow between fuel line 402 and combustion side line 408. A clamp body 620 of clamp assembly 600 can engage the flanges 403, 409 (shown in FIG. 4, hidden by clamp body 620 in FIG. 6) of flanged joint 400 between fuel line 402 and combustion side line 408 to retain clamp assembly 600 thereon and to retain a seal 601 (FIG. 7) therebetween, as will be described. Clamp body 620 can include one or more vents 628 to provide an outlet from clamp assembly 600 when desired as will also be described.

Turning now to FIG. 7, seal 601 can be held in clamp body 620 (FIG. 6) and can enable selective sealing of flanged joint 400 (FIG. 6). Seal 601 can have a generally toroidal shape, which includes a seal side wall 602 connecting a seal top wall 603 and a seal bottom wall 606. A first lip 604 can project from seal top wall 603 and can define a hole 605 therethrough to an interior 609 of seal 601. First lip 604 and seal top wall 603 can be sized and shaped to sealingly engage a corresponding opening of a flange of a flanged joint, such as first or second flange 403, 409 of flanged joint 400 of FIG. 4. A second lip 604′ can project from seal bottom wall 606 and can define a hole 605 (not shown in FIG. 7) therethrough to the interior 609 of seal 601. Second lip 604′ and seal bottom wall 606 can be sized and shaped to sealingly engage a corresponding opening of a flange of a flanged joint, such as first or second flange 403, 409 of flanged joint 400 of FIG. 4.

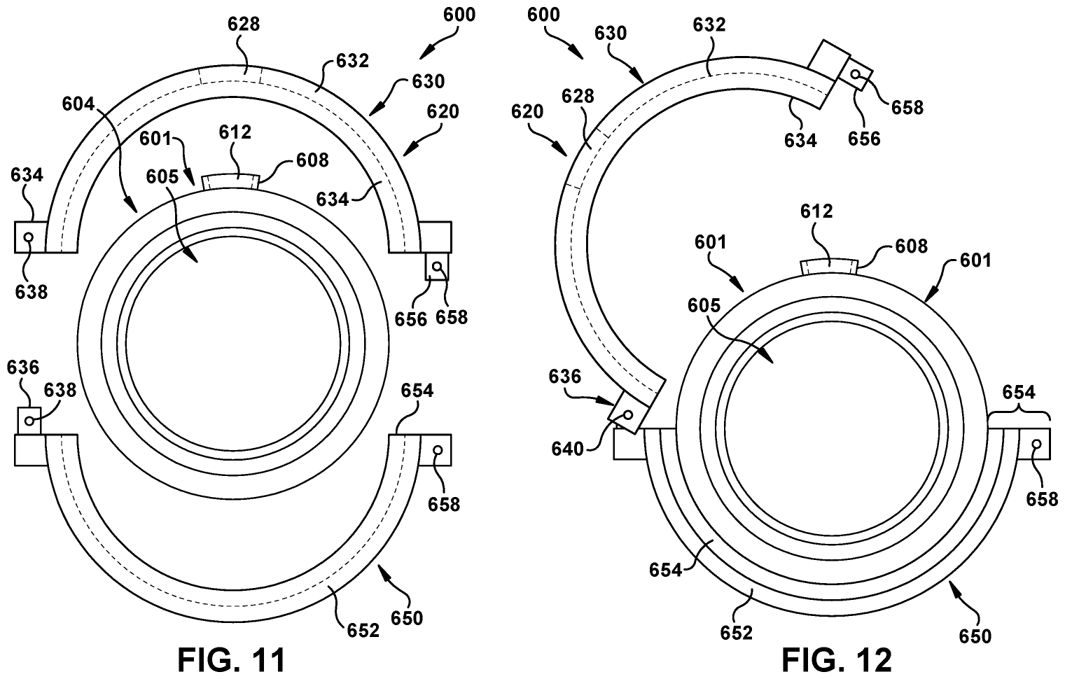

As seen in FIG. 7, in contrast to prior art blind seal 500 (FIG. 5), seal 601 can include at least one ear 608, 610 that projects radially outwardly from seal 601, such as from seal side wall 602, and includes a respective exit passage 612, 614 defined therethrough to an exterior of seal 601. Together, hole 605, an inner surface 607 of seal bottom wall 606, interior 609 of seal 601, and one or more of exit passages 612, 614 can form a channel where hole 605 is an inlet of the channel. As will be described, in the unsealed position of seal 601, exit passages 612, 614 of the channel are in fluid communication with respective vents 628 (FIG. 6), such as by each car 608, 610 and/or exit passage 612, 614 being aligned with a respective vent 628 (FIG. 6). In the sealed position of seal 601, fluid communication between the exit passage(s) 612, 614 and vent(s) 628 (FIG. 6) is blocked. It should be noted that while two ears 608, 610 are shown, embodiments can employ a single ear, exit passage, and vent (e.g., as shown in FIGS. 11-14) or more than two ears, exit passages, and vents. Where two or more ears are used, the ears are circumferentially spaced from one another.

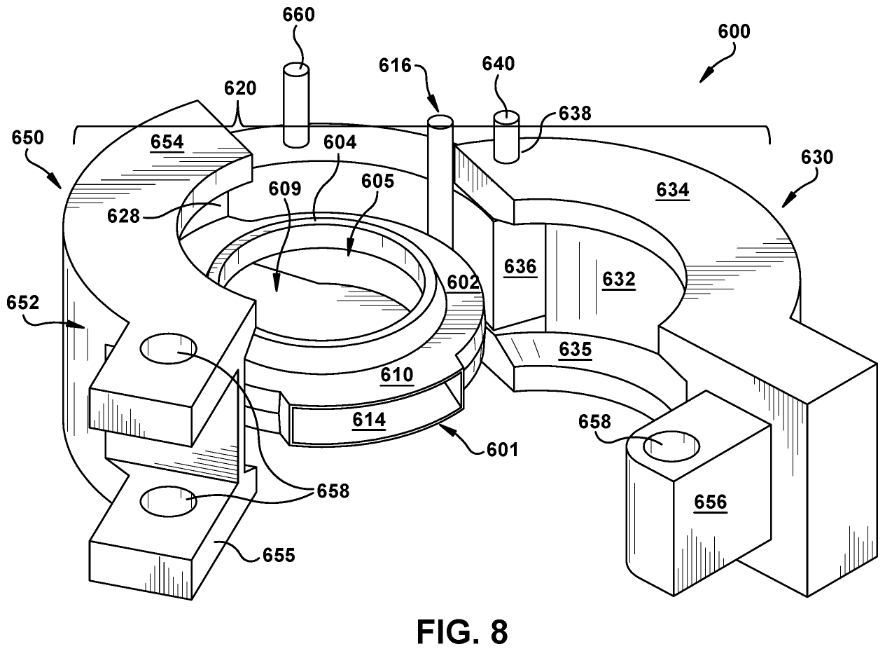

Seal 601 can include an actuator 616, such as a first pin, which can be used to move seal 601 between unsealed and sealed positions, as will be described. Actuator 616 need not take the form of a pin but could have any shape suitable and/or desired. Additionally, seal 601 can include a locking assembly on actuator 616 that can retain seal 601 in one or both of the unsealed and sealed positions. For example, a lock plate 617 can be mounted on an end of actuator 616 and can have a detent, such as a hole 618, that can selectively engage a corresponding feature on clamp body 620 (FIGS. 8-10) to retain actuator 616.

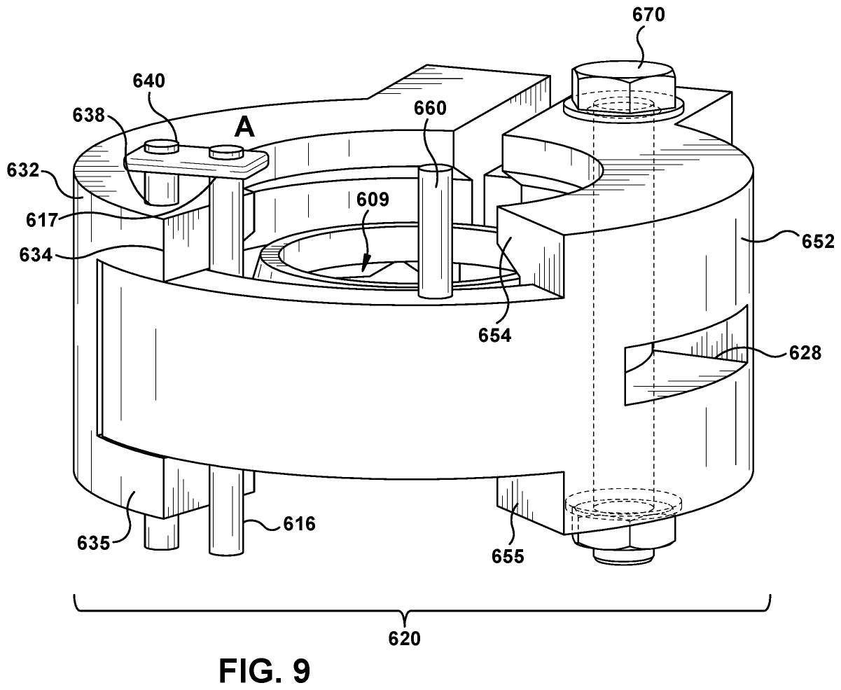

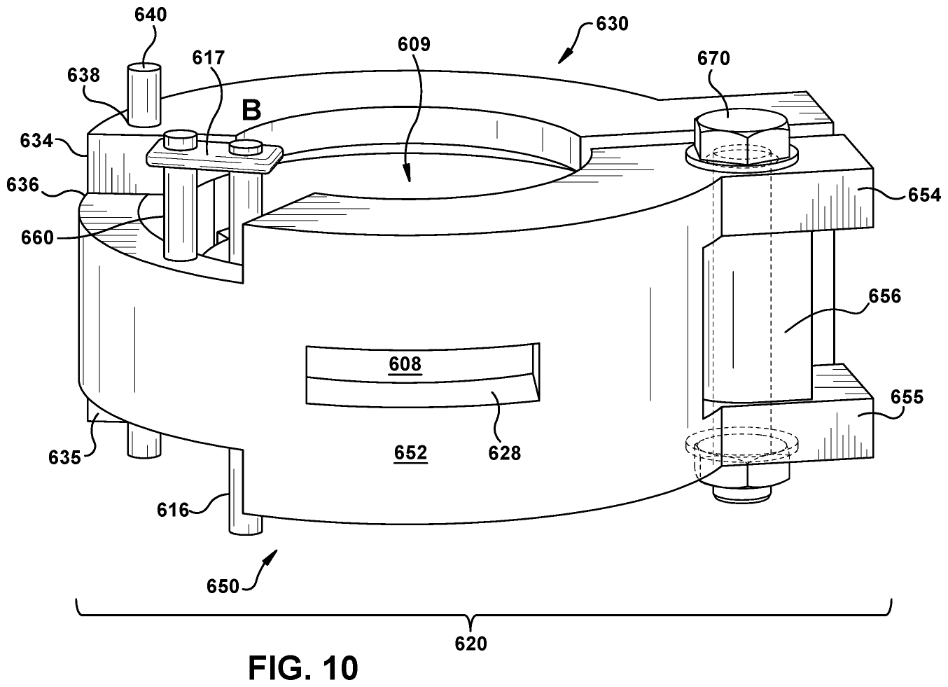

With additional reference to FIGS. 8-10, seal 601 of clamp assembly 600 can be supported by clamp body 620. FIG. 8 illustrates a perspective view of sealing clamp assembly 600 with clamp body 620 in an open position/state for mounting on or removal from a flange joint. FIG. 9 illustrates a perspective view of sealing clamp assembly 600 with clamp body 620 in a closed position/state, such as when mounted on a flange joint, and seal 601 in an unsealed position A. FIG. 10 illustrates a perspective view of sealing clamp assembly 600 with clamp body 620 in a closed position/state, such as when mounted on a flange joint, and seal 601 in a sealed position/state B, in accordance with embodiments of the present disclosure.

As illustrated in FIG. 8, clamp body 620 can include a first portion 630 connected to a second portion 650 such that, when assembled in a closed position, first portion 630 and second portion 650 can slidingly hold seal 601. First portion 630 can include a first outer wall section 632 and opposed end walls 634, 635 extending radially inward from first outer wall section 632 as a top wall 634 and a bottom wall 635. Similarly, second portion 650 can include a second outer wall section 652 and opposed end walls 654, 655 extending radially inward from a top and a bottom of second outer wall section 652 as a top wall 654 and a bottom wall 655. Thus, each of first portion 630 and second portion 650 can include respective outer wall sections 632, 652 that together form a clamp outer wall of clamp body 620. Similarly, each of first portion 630 and second portion 650 can include two opposed respective end walls 634, 635, 654, 655 projecting inward from respective outer wall sections 632, 652 to form a clamp top wall and a clamp bottom wall. In embodiments, the clamp top wall and the clamp bottom wall are sized to hold clamp assembly 600 on a flange, such as first or second flange 403, 409 of flanged joint 400 (FIGS. 4, 6).

As also seen in FIG. 8, first portion 630 and second portion 650 can be pivotably connected by a pivot pin 640 extending through corresponding holes 638 through first and second portions 630, 650. For example, a first tongue 636, which extends from an end of second portion 650, and end walls 634, 635 of first portion 630 can have corresponding holes 638 therethrough to receive pivot pin 640. This connection of first portion 630 and second portion 650 is also shown in FIGS. 12 and 16, though the bottom walls 635, 655 are not seen since they are top views. Similarly, as illustrated in FIG. 8, a second tongue 656, which extends from an end of first portion 630, and end walls 654, 655 of second portion 650 can have corresponding holes 658 therethrough to receive a locking pin 670 (FIG. 9). First tongue 636 and second tongue 638 may have a height in the radial direction that is equal to or less than the span between innermost surfaces of end walls 634, 635, 654, 655.

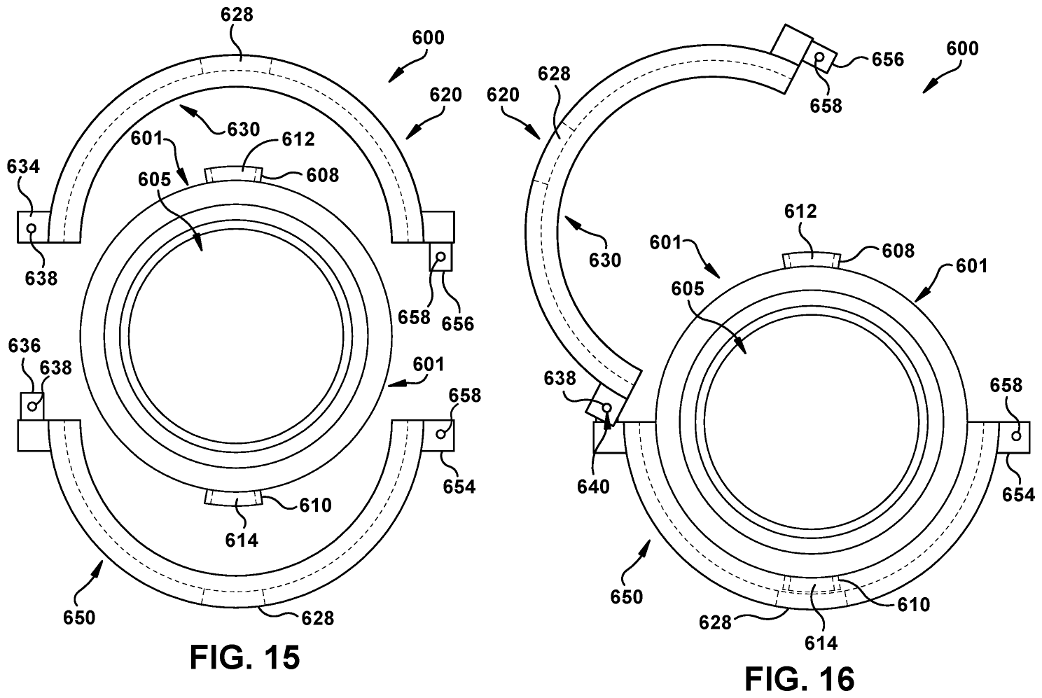

To retain clamp body 620 in the closed position, corresponding holes 658 for receiving a locking pin 670 (shown in FIGS. 9 and 10) can be formed through second tongue 656 and end walls 654, 655. Locking pin 670 need not be a pin per se, but can be any suitable form, such as a bolt, padlock hasp, wire, or the like. In embodiments, first tongue 636 can be formed on one of first portion 630 and second portion 650, and second tongue 656 can be formed on the other of first portion 630 and second portion 650. With additional reference to FIGS. 9 and 10, clamp assembly 600 may also include one or more vents 628 extending radially through respective outer wall sections 632, 652 of first portion 630 and second portion 650. In exemplary embodiments shown in FIGS. 11-14, a single vent can be used. In other embodiments shown in FIGS. 15-18, two vents can be used.

So configured, first portion 630 and second portion 650 can be pivotably connected by pivot pin 640 between the open clamp position seen in FIG. 8, and the closed clamp position seen in FIGS. 9 and 10. In the open clamp position, at least one of first portion 630 or second portion 650 is disengaged from seal 601. In the closed clamp position, first portion 630 and second portion 650 engage seal 601, end walls 634, 635, 654, 655 of first portion 630 and second portion 650 being sized to retain clamp assembly 600 on flanged joint 400 (FIGS. 4 and 6), with second tongue 656, opposed end walls 654, 655, and locking pin 670 acting as a locking assembly.

Scaling of exit passages 612, 614 when seal 601 is in the sealed position B can occur in a number of ways. For example, the outer wall of clamp body 620 can be employed in various ways to block fluid flow through exit passages 612, 614. In the illustrated embodiment, an inner diameter of clamp body 620 can be sized so that an inner surface of the outer wall of clamp body 620 slidingly engages the outer edges of cars 608, 610 of seal 601. Alternatively, the inner diameter of clamp body 620 can be sized to slidingly engage an outer surface of side wall 602 of seal 601, and grooves can be formed on the inner surface of the outer wall of clamp body 620 to accommodate cars 608, 610 in the sealed position B, in the unsealed position A, and therebetween. In addition, actuator 616 can be formed or placed on seal 601 so that its radial extent stays within the outer diameter of seal 601. These are only non-limiting examples, and other ways of sealing exit passages 612, 614 fall within the scope of embodiments. It should also be noted that a number of cars 608, 610, exit passages 612, 614, and vents 628 should be selected and sized to safely accommodate an expected volume of air over a desired period.

FIG. 9 shows the example embodiment of clamp assembly 600 with first pin 616 in a first position corresponding to seal 601 occupying the unsealed position A. In this position, exit passages 612, 614 of cars 608, 610 of seal 601 are aligned with vents 628 through the clamp outer wall so that hole 605 (FIG. 7) is in fluid communication with an exterior of clamp assembly 600. In this position, when sealing clamp assembly 600 is mounted on an end of a fuel line 402, fluid in fuel line 402 can pass through the channel of seal 601 to the surroundings. That is, fluid in fuel line 402 can pass through hole 605 to the interior of seal 601, along inner surface 607 of seal bottom wall 606, through at least one ear 608, 610 and respective exit passage 612, 614, and through at least one respective vent 628 in the clamp outer wall to an exterior of sealing clamp assembly 600.

By contrast, FIG. 10 shows the example embodiment of sealing clamp assembly 600 with actuator 616 in a second position corresponding to seal 601 occupying the sealed position B. In this position, fluid communication between exit passages 612, 614 and the exterior of sealing clamp assembly 600 is blocked, such as by the clamp outer wall. Fluid in fuel line 402 will therefore be prevented from escaping since the fluid cannot pass through the seal channel to the exterior of sealing clamp assembly 600, such as during the blow step of an air blow or clearing procedure, or during pressurization for a leak test.

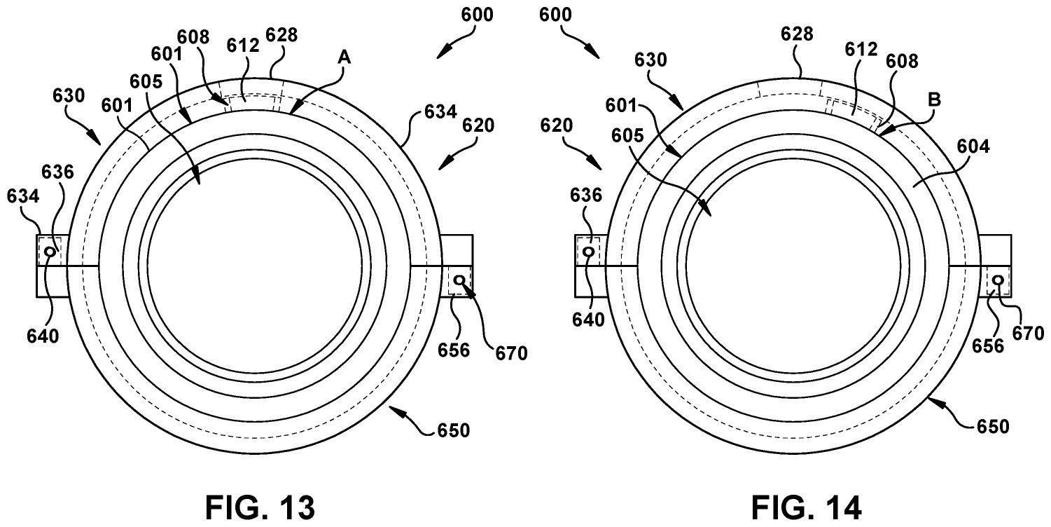

FIGS. 11-18 provide additional illustrations of the elements and construction of embodiments of clamp assembly 600. First portion 630 can be constructed similarly to second portion 650 in embodiments, particularly at ends thereof. As seen in FIGS. 11-14, seal body 601 can include one ear 608 in embodiments, with an exit passage 612 defined through ear 608. In such embodiments, clamp body 620 can include one vent 628, such as through outer wall section 632 of first portion 630 of clamp body 620. In FIG. 11, sealing clamp assembly is shown disassembled in part to illustrate a relationship between seal 601 and first and second portions 630, 650 of clamp body 620. In FIG. 12, pivot pin 640 has been inserted in holes 638 to connect one side of first and second portions 630, 650. In FIG. 13, first and second portions 630, 650 have been closed around seal 601 and are held closed by locking pin 670. In FIG. 13, seal 601 is shown in unsealed position A in which exit passage 612 is aligned with vent 628, placing the interior of seal 601 in fluid communication with the exterior of clamp assembly 600. Seal 601 is shown in sealed position B in FIG. 14, in which the clamp body outer wall, such as outer wall section 632 of first portion 630, blocks exit passage 612 and thus blocks fluid communication between the interior of seal 601 and the exterior of clamp assembly 600. It should be noted that vent 628 and/or ear 608 can occupy any suitable position and can be sized to accommodate the needs of a particular installation.

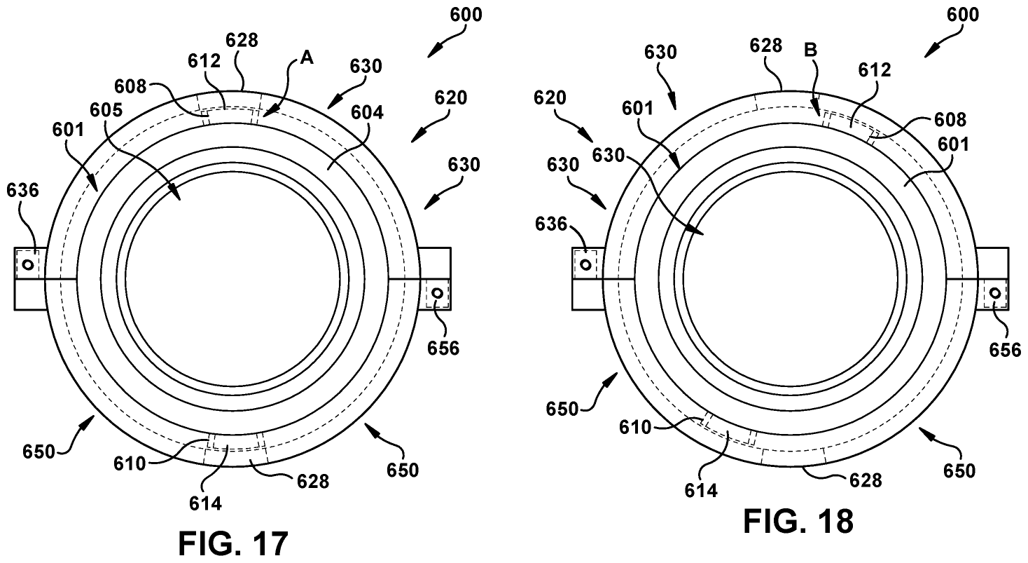

FIGS. 15-18 illustrate an embodiment in which seal 601 has a first ear 608 and a second ear 610 with respective exit passages 612, 614. In this embodiment, a second vent 628 is formed through outer wall section 652 of second portion 650. As in the previous example, FIG. 16 shows first and second portions 630, 650 pivotably connected by pivot pin 670, and FIGS. 17-18 show first and second portions 630, 650 held closed by locking pin 670. Similar to the single-ear embodiments illustrated in FIGS. 11-14, the two-ear embodiment can occupy an unsealed position A (FIG. 17) in which exit passages 612, 614 are aligned with respective vents 628, placing the interior of seal 601 in fluid communication with the exterior of clamp assembly 600. Likewise, seal 601 can occupy a sealed position B (FIG. 18) in which the clamp body outer wall, such as outer wall section 632 of first portion 630 and outer wall section 652 of second portion 650, each block a respective exit passage 612, 614 and thus block fluid communication between the interior of seal 601 and the exterior of clamp assembly 600. As above, it should be noted that vents 628 and/or ears 608, 610 can occupy any suitable positions and can be sized to accommodate the needs of a particular installation. In addition, it should be clear that embodiments could include more than two ears if suitable and/or desired.

Returning to FIGS. 9 and 10 and with additional reference to FIG. 7, in certain embodiments, a lock plate 617 can extend from an end of actuator 616, here a first pin, and can include a detent 618 (FIG. 7), such as a hole, sized to receive a first lock projection, here, for example, pivot pin 640, and/or a second lock projection 660. First lock projection/pivot pin 640 is removable from sealing clamp assembly 600, as discussed above, while second lock projection 660 is fixedly mounted to second portion 650 of clamp body 620 and extends radially outward beyond end wall 654. First lock projection/pivot pin 640 and second lock projection/pin 660 are circumferentially spaced apart from one another.

Lock plate 617 can be mounted on first pin 616 (actuator) via a suitable hole formed in lock plate 617 to allow lock plate 617 to slide along and/or rotate around first pin 616. Thus, for the example shown (FIG. 9), when seal body 601 is in unsealed position A, first pin 616 is in a corresponding position, and lock plate 617 can be rotated to allow insertion of first lock projection/pivot pin 640 through hole 618 to retain first pin 616, which in turn retains seal 601 in the unsealed position A. Likewise, when seal 601 is in sealed position B (FIG. 10), first pin 616 is in a corresponding position, and lock plate 617 can be rotated to allow insertion of second locking projection 660 through hole 618 to retain first pin 616, which in turn retains seal 601 in the sealed position B. Actuator pin 616 with its lock plate 617 and detent 618, when selectively engaged with pivot pin 640 and lock projection/pin 660, can thus form an effective and easily used locking assembly for seal 601 with clamp body 620, which can ensure that seal 601 remains in a desired state during use of sealing clamp assembly 600.

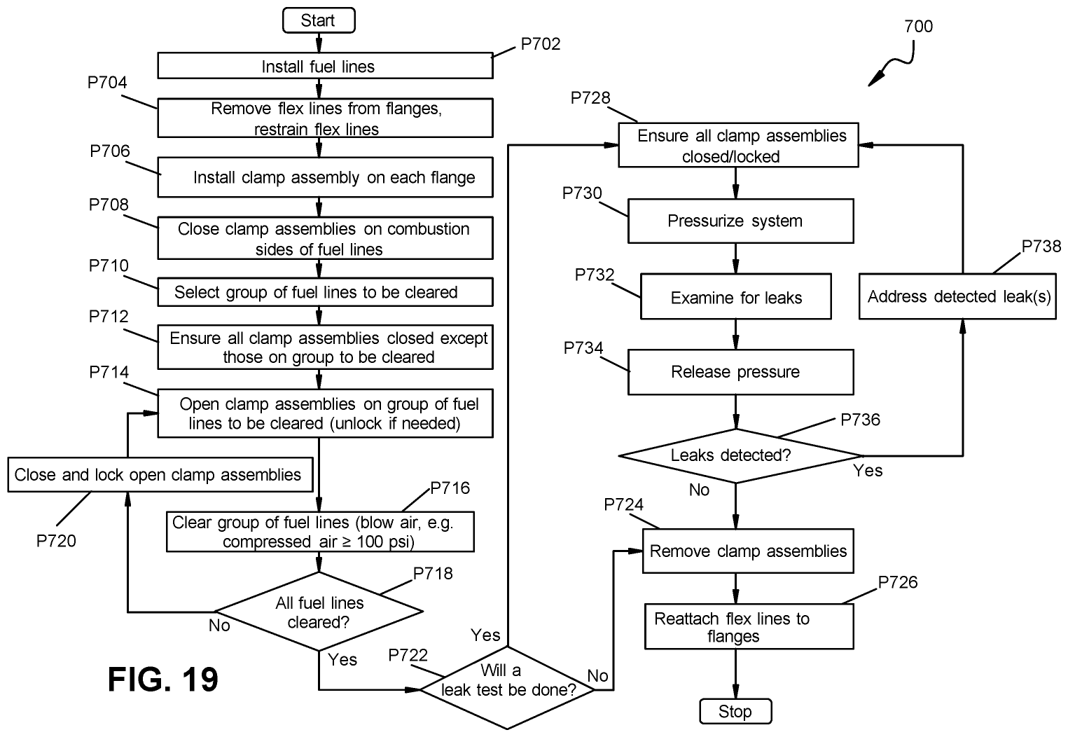

With embodiments in accordance with the disclosure herein, and with reference to FIG. 19, a method 700 for clearing and/or leak testing fuel lines of a gas turbine engine fuel supply system can be performed that can enjoy significant time and labor savings over the prior art. Method 700 can include installing fuel lines (P702) of a fuel supply system of a gas turbine engine, removing flex lines of the fuel lines from respective flanged joints thereof, thereby exposing respective flanges thereof (P704), and installing a respective clamp assembly 600 on each flange (P706), each clamp assembly having a first state (unsealed position A) in which flow through the flange is allowed and a second state (sealed position B) in which flow through the flange is blocked. When installing each respective clamp assembly 600, it has been found advantageous to close clamp assemblies 600 on the combustion sides of the fuel lines (P708).

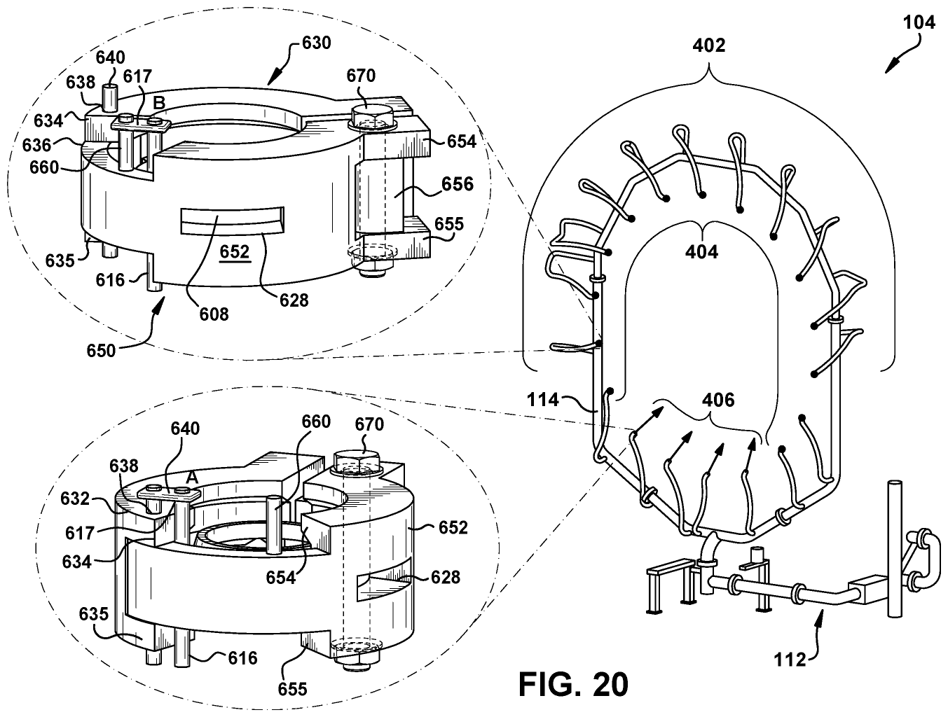

Method 700 can further include selecting a group of fuel lines to be cleared (P710), ensuring the respective clamp assemblies of all fuel lines other than the group of fuel lines to be cleared are in the second state (P712), and placing the respective clamp assemblies of the group of fuel lines in the first state (P714). This is also illustrated in FIG. 20, where the upper inset shows clamp assemblies in the second (sealed) state on most of the lines, and the lower inset shows clamp assemblies in the first (unsealed) state on a group of lines to be cleared. For clamp assemblies including a suitable locking assembly as described above, placing a clamp assembly in the first state or the second state can include locking the clamp assembly in that state. The group of fuel lines can be cleared (P716), such as by blowing compressed air through the fuel lines, in which case a pressure of at least 100 psi can be preferred in embodiments. Selecting a group of fuel lines (P710), opening the respective clamp assemblies (P714), and clearing (P716) can be repeated until all fuel lines have been cleared. That is, if all fuel lines have not been cleared (P718), the group's clamp assemblies can be closed (P720) and new groups' clamp assemblies can be opened (P714) and cleared (P716) until all fuel lines are cleared (P720).

Of particular note, when a group of lines has been cleared, the clamp assemblies remain in place and are changed from one state to another (closed to open or vice versa). This represents a savings in time and labor over prior art techniques and/or devices in which blocking seals have to be installed on a first group to be cleared, uninstalled from the first group after the clearing procedure, and installed on a second group to be cleared, etc. as groups of lines are cleared in sequence.

When all fuel lines have been cleared in method 700, if a leak test is not to be performed, all clamp assemblies can be removed (P724), and all flex hoses can be reattached (P726). However, if a leak test is to be performed (P722), method 700 can include ensuring all clamp assemblies are closed (P728), pressurizing the system (P730), examining for leaks (P732), and releasing pressure from the system (P734). If no leaks were detected (P736), all clamp assemblies can be removed (P724), and the flex lines can be reattached (P726). If any leak(s) were detected (P736), the leak(s) can be addressed (P738), and the steps of pressurizing (P730), examining for leaks (P732), and releasing pressure (P734) can be repeated until no leaks are detected. Implicit in this leak test portion of method 700 is the fact that the clamp assemblies 600 used in the air blow/clearing portion of method 700 are left in place for use during the leak test, which is a significant departure from previous techniques. As a result, the time and labor associated with removing the seals used in air blow/clearing procedures and installing prior art seals suitable for leaks tests are eliminated, as are the costs associated with the prior art seals.

As can be appreciated, a technical effect of embodiments disclosed herein is a reduction in time, labor, and potentially cost associated with swapping of seals on gas turbine fuel lines during an air blow/clearing procedure. Another technical effect of embodiments disclosed herein is a reduction in time, labor, and cost associated with performing a leak test after performing an air blow/clearing procedure since the inventive clamp assemblies used during the air blow/clearing procedure remain installed for the leak test procedure.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A clamp assembly for selectively blocking flow from a flanged joint of a fuel line of a gas turbine fuel supply system, the clamp assembly comprising:
a clamp body configured to surround the flanged joint of the fuel line, the clamp body including an outer wall with a first vent formed therethrough; and
a seal movably mounted in and supported by the clamp body, the seal including:
a central opening in a top of the seal and in fluid communication with an interior of the seal; and
a first exit passage defined in the seal and in fluid communication with the interior of the seal and with an exterior of the seal,
wherein the seal is movable between an unsealed position in which the central opening of the seal is in fluid communication with an exterior of the clamp assembly through the first exit passage and the first vent, and a sealed position in which fluid communication from the central opening to the exterior of the clamp body through the first exit passage is blocked by the clamp body.

2. The clamp assembly of claim 1, wherein the first exit passage is aligned with the first vent in response to the seal being in the unsealed position, and wherein the first exit passage is completely covered by the outer wall of the clamp body in response to the seal being in the sealed position.

3. The clamp assembly of claim 1, wherein the seal includes a first ear projecting radially from the seal body and that defines at least part of the first exit passage.

4. The clamp assembly of claim 3, wherein the seal includes a second exit passage defined in the seal body in fluid communication with the interior of the seal and with the exterior of the seal; wherein the clamp body further includes a second vent through the outer wall of the clamp body; and wherein the second exit passage is aligned with the second vent in response to the seal being in the unsealed position, and the second exit passage is completely covered by the outer wall of the clamp body in response to the seal being in the sealed position.

5. The clamp assembly of claim 4, wherein the seal further includes a second ear circumferentially spaced from the first ear, and each of the first ear and the second ear project radially from the seal body and define at least part of the first exit passage and the second exit passage, respectively.

6. The clamp assembly of claim 1, wherein the clamp body further includes a first portion connected to a second portion.

7. The clamp assembly of claim 6, wherein the first portion and the second portion are pivotably connected and are movable between:
an open clamp position in which at least one of the first portion or the second portion is disengaged from the seal; and
a closed clamp position in which the first portion and the second portion engage the seal and are configured to retain the clamp assembly on the flanged joint.

8. The clamp assembly of claim 6, wherein each of the first portion and the second portion includes a respective outer wall section, opposed end walls extending radially inward from the respective outer wall section as a top wall and a bottom wall, and a tongue extending from an end of the respective first or second portion.

9. The clamp assembly of claim 8, wherein the opposed end walls are sized and configured to hold the clamp assembly on the flanged joint.

10. The clamp assembly of claim 8, wherein the tongue of the first portion is positioned between the end walls of the second portion adjacent the first portion; and wherein the first portion and the second portion are pivotably connected by a pivot pin extending through corresponding holes formed through the tongue of the first portion and through the end walls of the second portion adjacent the tongue of the first portion.

11. The clamp assembly of claim 10, wherein, when the clamp assembly is in a closed clamp position:
the tongue of the second portion is positioned between the end walls of the first portion adjacent the second portion at a location circumferentially spaced from the pivot pin; and
a removable locking pin extends through corresponding holes formed through the tongue and through the end walls of the first portion adjacent the tongue of the second portion.

12. The clamp assembly of claim 1, further comprising an actuator accessible from the exterior of the clamp assembly and operable to move the seal between an unsealed position in which the interior of the seal is in fluid communication with an exterior of the clamp assembly through the first exit passage and the first vent, and a sealed position in which fluid communication from the interior of the seal to the exterior of the clamp body through the first exit passage is blocked.

13. The clamp assembly of claim 12, wherein the actuator extends from the seal to the exterior of the clamp assembly.

14. The clamp assembly of claim 12, wherein the actuator further includes a lock plate that interacts with a feature on the clamp body to selectively retain the seal in each of the unsealed position and the sealed position.

15. The clamp assembly of claim 14, wherein the lock plate includes a detent that interacts with the feature on the clamp body; wherein, when the seal is in the sealed position, the feature on the clamp body that interacts with the detent is a pivot pin coupling the first portion and the second portion; and wherein, when the seal is in the unsealed position, the feature on the clamp body that interacts with the detent is a lock projection extending from the clamp body and circumferentially spaced from the pivot pin.

16. The clamp assembly of claim 1, wherein the outer wall of the clamp body is substantially annular, and the seal is substantially toroidal.

17. A method comprising:
removing flex lines of fuel lines of a fuel supply system of a gas turbine engine from respective flanged joints thereof, thereby exposing respective flanges thereof;
installing a respective clamp assembly on each flange, each clamp assembly having a first state in which flow through the flange is allowed and a second state in which flow through the flange is blocked;
selecting a group of fuel lines to be cleared;
placing the respective clamp assemblies of all fuel lines other than the group of fuel lines to be cleared in the second state;
placing the respective clamp assemblies of the group of fuel lines in the first state;
clearing the group of fuel lines;
repeating selecting a group of fuel lines, placing the respective clamp assemblies in an appropriate first state or second state, and clearing the fuel lines in groups until all fuel lines have been cleared;
removing the clamp assemblies; and
reattaching the flex lines to the flanges.

18. The method of claim 17, wherein placing the respective clamp assemblies in at least one of the first state or the second state includes locking the respective clamp assemblies.

19. The method of claim 17, further comprising, after all fuel lines have been cleared and before removing the clamp assemblies, performing a leak test by:
placing all clamp assemblies in the second state;
pressurizing the fuel supply system;
examining the fuel supply system for leaks;
addressing each detected leak, if any;
repeating examining and addressing until no leak is detected;
depressurizing the system;
removing the clamp assemblies; and
reattaching the flex lines to the flanges.
